(19) United States
(12) Patent Application Publication
(10) Pub. No.: US 2025/0162953 A1
(43) Pub. Date: May 22, 2025

(54) USE OF ADHESIVES, SEALANTS, OR COATINGS ON GREEN CONCRETE AND OTHER HIGHLY ALKALINE SUBSTRATES

(71) Applicant: SIKA TECHNOLOGY AG, Baar (CH)

(72) Inventors: Steffen MAIER, Wettingen (CH); Antonio BAZZO, Zürich (CH)

(73) Assignee: SIKA TECHNOLOGY AG, Baar (CH)

(21) Appl. No.: 18/841,560

(22) PCT Filed: Mar. 14, 2023
(86) PCT No.: PCT/EP2023/056433

§ 371 Date: Aug. 26, 2024

(30) Foreign Application Priority Data
Mar. 23, 2022 (EP) 22163821.6

(51) Int. Cl. C04B 41/48; C04B 41/00; C09D 5/02; C09D 133/10

(52) U.S. Cl. CPC C04B 41/483; C04B 41/009; C09D 5/027; C09D 133/10

(57) ABSTRACT

The use of a water-based polymer dispersion composition including more than 20% by weight, based on the total composition, of at least one water-dispersed polymer P, dispersed in water in a concentration between 40 and 80% by weight based on the dispersion of water-dispersed polymer P, at least one surfactant, at least one dispersant, and optionally at least one plasticizer PL having at least one ester or ether group, as an adhesive, sealant, or coating applied onto at least one alkaline substrate having a pH of at least 10 when wetted with water. The at least one water-dispersed polymer P has a glass transition temperature T_{g}, determined with DSC according to ISO 11357 standard, of <0° C. The alkaline substrate is fresh concrete, fresh cement mortar, fresh lime mortar, or a fresh lime or silicate paint.

### TECHNICAL FIELD

The invention relates to the use of adhesives, sealant, or coating compositions on highly alkaline substrates selected from fresh concrete, fresh cement mortar, fresh lime mortar, or a fresh lime or silicate paint, as well as a method for applying such compositions on such substrates.

### BACKGROUND OF THE INVENTION

Curable or dryable compositions, in particular based on polyurethanes or silane-modified polymers (SMP), are often used as adhesives, sealants or coatings in the construction sector. Typical substrates for the application of such products originate from cement-, lime- or silicate-bound building materials such as concrete or cement mortar. When these building materials have only recently been applied or processed and the substrates in the form of foundations, walls, screeds, renders etc. are thus still fresh, they have a markedly alkaline surface with pH values of 10 or higher, since the hydroxides present therein have not yet been carbonated. Fresh concrete is also referred to as “young” or “green” or “wet”. In this state, the still highly alkaline substrate is very problematic for the composition applied thereon, since the high alkalinity and the high water content of the not yet dried substrate can severely impact the curing behavior or the mechanical properties of the composition applied on such substrates. In order to protect the adhesive, sealant, or coating composition from contact with the alkaline surface, the substrate must be left to age and dry sufficiently, which takes time, or else pretreated prior to the application of the composition, for example by neutralization by means of a fluate, for example a fluoridosilicate, or by sealing by means of a primer, for example an epoxy resin coating. In practice, however, this is frequently not done in order to save time and money. In the boundary layer, hydrolysis reactions of constituents of the sealant, adhesive, or coating composition can occur under the alkaline conditions, which can result not only in significantly impaired adhesion of the sealant, adhesive, or coating composition on the substrate, but also in troublesome odor emissions, impaired curing or final performance, or even chemical degradation of the composition. Among the sensitive compounds are in particular the plasticizers that are present in most compositions of this kind, or curing catalysts, or the binder polymer matrix itself. Typical used sensitive plasticizers are fatty alcohol dicarboxylic esters such as diisodecyl phthalate (DIDP), diisononyl cyclohexane-1,2-dicarboxylate (DINCH) or di(2-ethylhexyl) adipate (DOA). Hydrolysis thereof leads to release of the fatty alcohols, which have a highly unpleasant smell and migrate into the pore structure of the substrates and thence evaporate or are washed out into the environment and cause a musty odor over a long period of time. Such long-lasting odor nuisance is observed particularly in the case of bonding of parquet on fresh cement screed by means of elastic polyurethane or SMP adhesives. Curable compositions such as polyurethanes or SMP furthermore often contain curing catalysts that may be impaired by the high alkalinity of the green concrete and other such highly alkaline substrates. This may lead to sluggish or incomplete curing of such compositions.

Hence, up to now, in order to properly use an adhesive, sealant or coating composition on from fresh concrete, fresh cement mortar, fresh lime mortar, or a fresh lime or silicate paint substrate, it was required to wait sufficiently long for the substrate to dry and decrease its alkalinity in order to be able to apply the composition thereon and obtain a properly performing adhesive, sealant, or coating on these substrates. For example, typical polyurethane or silicone compositions may require weeks of substrate drying in order to properly and continually adhere to such substrates and not show signs of degradation.

Of course, it would thus be desirable to have an adhesive, sealant, or coating composition that can be applied directly on still highly alkaline and wet substrates including fresh concrete, fresh cement mortar, fresh lime mortar, or a fresh lime or silicate paint, or after much shorter waiting times of a few days or less, while the composition cures or dries and adheres properly and does not degrade.

### SUMMARY OF THE INVENTION

The object of the present invention is to provide the use of a defined composition as an adhesive, sealant or coating applied onto at least one alkaline substrate having a pH of at least 10 when wetted with water, wherein the alkaline substrate is fresh concrete, fresh cement mortar, fresh lime mortar, or a fresh lime or silicate paint. Hence, suitable such compositions for this intended use are to be provided that are applied onto such substrates within a very short time after deposition or production of the substrate, for example within a few days or less, and that properly cure or dry, continually adhere on the substrate, and do not show signs of degradation of the composition itself or its constituents.

Surprisingly, it was found that water-based compositions according to claim 1 can be used in such applications and bring about the long-desired stability and working efficiency. When used as claimed in claim 1, they can be applied onto the still alkaline and wet substrate only a few days or less after the substrate's fabrication, yet still cure or dry readily and without any signs of degradation, even if they contain plasticizers. Furthermore, they exhibit excellent and lasting adhesion on these substrates.

According to another aspect of the present invention, a method for sealing a joint, adhesively bonding two substrates, or coating a surface is provided.

Preferred embodiments are object of the dependent claims.

### DETAILED DESCRIPTION OF THE INVENTION

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “polymer” in the present document encompasses on the one hand a collective of chemically uniform macromolecules which nevertheless differ in respect of degree of polymerization, molar mass, and chain length, which collective has been prepared through a polymerization reaction (chain growth addition polymerization, free radical polymerization, polyaddition, polycondensation). On the other hand, the term also encompasses derivatives of such a collective of macromolecules from polymerization reactions, in other words compounds which have been obtained by reactions, such as additions or substitutions, for example, of functional groups on existing macromolecules and which may be chemically uniform or chemically non-uniform.

“Molecular weight” of oligomers or polymers is understood in the present document to be the molecular weight average Mₙ (number average), which is typically determined by means of GPC against polystyrene as standard.

The unit term “wt.-%” means percentage by weight, based on the weight of the respective total composition, if not otherwise specified. The terms “weight” and “mass” are used interchangeably throughout this document.

All industrial norms and standard methods mentioned in this document are referring to the respective current versions at the time of filing.

The term “(meth)acrylic” designates methacrylic or acrylic. Accordingly, the term “(meth)acrylate” designates methacrylate or acrylate.

The term “polyacrylate polymer” designates polymers resulting from the free-radical polymerization of two or more (meth)acrylate monomers. Copolymers of the (meth)acrylate monomers and copolymers of (meth)acrylate monomers with other vinyl group containing monomers are also included within the term “polyacrylate polymer”. The terms “polyacrylate polymer”, “polyacrylate” and “acrylate polymer” are used interchangeably.

The term “shelf life” designates a time period after which a dispersion adhesive composition has substantially coagulated, separated or settled such that it cannot be readily applied to a surface of a substrate as homogeneous, uniform film or bead.

The term “storage stable composition” designates a composition, which has a shelf life of greater than six months when stored at room temperature and at a relative humidity (abbreviated “r.h.”) of 50% when stored in a closed container. The term “room temperature” (abbreviated “RT”) designates a temperature of 23° C.

The term “standard pressure” designates an absolute pressure of 1 bar.

The present invention relates in a first aspect of the invention to use of a water-based polymer dispersion composition comprising
a) more than 20% by weight, based on the total composition, of at least one water-dispersed polymer P, dispersed in water in a concentration of between 40 and 80% by weight based on the dispersion of water-dispersed polymer P, wherein said at least one water-dispersed polymer P has a glass transition temperature T_{g}, determined with DSC according to ISO 11357 standard, of <0° C.,
b) at least one emulsifier, preferably a non-ionic emulsifier,
c) at least one dispersant, in particular a polymeric ammonium salt of a carboxylic acid copolymer, and
d) optionally at least one plasticizer PL having at least one ester or ether group,
   as an adhesive, sealant, or coating applied onto at least one alkaline substrate having a pH of at least 10 when wetted with water, wherein the alkaline substrate is fresh concrete, fresh cement mortar, fresh lime mortar, or a fresh lime or silicate paint.

The alkaline substrate is a fresh, meaning incompletely carbonated substrate based on cement, lime (calcium hydroxide) and/or silicate (waterglass). More specifically, the alkaline substrate is a fresh concrete, fresh cement mortar, fresh lime mortar or a fresh lime or silicate paint. The term “fresh” in connection with those substrates is used synonymously with the terms “young” or “green” or “wet” in the same context.

The pH of the water-wetted alkaline substrate can be determined with pH indicator paper or a pH meter or indicator or any other suitable method to determine the pH of an aqueous alkaline solution.

A concrete or other alkaline substrate as described above is referred to as “fresh” for as long as it still gives an alkaline reaction with a pH of 10 or higher. The period of time during which a concrete or other alkaline substrate of this context is still fresh depends on its setting time and the ambient temperature. The period of time typically varies within the range from 1 to 10 days.

The term “dispersion” refers to a physical state of matter that includes at least two distinct phases, wherein a first phase is distributed in a second phase, with the second phase being a continuous medium. Preferably, the dispersion comprises a solid phase which is dispersed as solid particles in a continuous liquid phase.

The term “aqueous polymer dispersion” refers to a polymer dispersion having water as the main carrier. Preferably, the “aqueous” refers to a 100% water carrier. Compounds denoted as PIB, ALK, or PL, or common additives known to the skilled person in the field of aqueous polymer dispersions, in this document are not considered carriers in this perspective.

Preferably, the dispersion adhesive composition comprises less than 5% by weight, preferably less than 1% by weight, based on the total weight of the dispersion adhesive composition, of volatile organic compounds having a boiling point of less than 150° C.

The aqueous polymer dispersion comprises of one or more water-dispersed polymers P, preferably free-radically polymerized polymer(s) obtained from ethylenically unsaturated monomers. Preferably, such polymers contain principal monomers selected from the group consisting of C₁-C₂₀-alkyl (meth)acrylates, vinyl esters of carboxylic acids containing up to 20 carbon atoms, vinyl aromatic compounds containing up to 20 carbon atoms, ethylenically unsaturated nitriles, vinyl halides, non-aromatic hydrocarbons having at least two conjugated double bonds, or mixtures of these monomers.

Preferably, the monomers of polymer P consists of by greater than 50% by weight of acrylic monomers. Acrylic monomers are defined herein as including (meth)acrylic acid, esters of (meth)acrylic acid, amides of (meth)acrylic acid, and nitriles of (meth)acrylic acid. As an ethylenically unsaturated monomer, acrylic ester monomers including methyl acrylate, ethyl acrylate, butyl acrylate, 2-ethylhexyl acrylate, decyl acrylate, methyl methacrylate, butyl methacrylate, isodecyl methacrylate, hydroxyethyl acrylate, hydroxyethyl methacrylate, and hydroxypropyl methacrylate, acrylamide or substituted acrylamides, styrene or substituted styrenes, butadiene, vinyl acetate or other vinyl esters, acrylonitrile or methacrylonitrile, may be used. Silicon-containing monomers such as, for example, vinyl trialkoxysilanes including vinyl trimethoxysilane, allyl trialkoxysilanes including allyl trimethoxysilane, (meth)acryloxyalkyl trialkoxysilanes including methacryloxypropyl trimethoxysilane, (meth)acryloxyalkyl alkyldialkoxysilanes including methacryloxypropyl methyldiethoxysilane, (meth)acryloxyalkoxyalkyl trialkoxy silanes including methacryloxyethoxyethyl trimethoxysilane, and mercaptoalkyl trialkoxysilanes including mercaptopropyl trimethoxysilane may also be incorporated, preferably at a level of from 0.01% to 6%, by weight based on the weight of the polymer P. Low levels of ethylenically-unsaturated monocarboxylic acids such as, for example, from 0 to 7%, by weight, based on the weight of polymer P, methacrylic acid or acrylic acid, may be used.

Suitable and preferred polymers P include, for example, polyvinyl acetate, polyvinyl alcohol, polyacrylates, polyurethanes, polyurethane-acrylates, natural based polymers, carboxylated polystyrene-compolymers, carboxylated butadiene styrene copolymers, carboxylated butadiene rubbers styrene-butadiene copolymers, styrene-isoprene copolymers, ethylene-vinyl acetate copolymers (EVA), ethylene-methacrylate copolymers, ethylene-ethyl acrylate copolymers, ethylene-butyl acrylate copolymers (EBA), ethylene-(meth)acrylic acid copolymers, ethylene-2-ethylhexyl acrylate copolymers, ethylene-acrylic ester copolymers, and polyolefinc block copolymers.

The above-mentioned copolymers, meaning polymers made from more than one type of monomer, can be block type copolymers or random copolymers.

Polymers P can also be further functionalized, meaning they can contain further functional groups such as hydroxyl, carboxy, anhydride, acrylate, and/or glycidylmethacrylate groups.

Preferably, the water-dispersed polymer P contains monomers mentioned further above and mixtures thereof in an amount of 60-100%, more preferably 85-100%, most preferably 95-99.8%, based on the weight of the polymer.

Preferred C₁-C₂₀-alkyl (meth)acrylates used in polymer P include (meth)acrylic acid alkyl esters having a C₁-C₁₂ alkyl radical, such as methyl (meth)acrylate, n-butyl acrylate, ethyl acrylate, and 2-ethylhexyl acrylate. Polymers P obtained by polymerization of mixtures of acrylic acid alkyl esters and (meth)acrylic acid alkyl esters can be mentioned as particularly suitable polymers P.

Suitable vinyl esters of carboxylic acids containing up to 20 carbon atoms include, for example, vinyl laurate, vinyl stearate, vinyl propionate, vinyl esters of tertiary saturated monocarboxylic acids, vinyl acetate, and mixtures of two or more thereof.

Suitable vinyl aromatic compounds include, for example, vinyltoluene, α- and p-methylstyrene, α-butylstyrene, 4-n-butylstyrene, 4-n-decylstyrene and styrene. Acrylonitrile and methacrylonitrile are presented as examples of suitable nitriles.

Suitable vinyl halides include, for example ethylenically unsaturated compounds substituted by chlorine, fluorine or bromine, such as vinyl chloride or vinylidene chloride, and mixtures thereof.

For the preparation of suitable water-dispersed polymers P there are furthermore suitable non-aromatic hydrocarbons containing from 2 to 8 carbon atoms and at least two olefinic double bonds, such as butadiene, isoprene and chloroprene.

Further monomers that may preferably be present in the water-dispersed polymer P in an amount of 0-40% by weight, preferably from 0-20% by weight and most preferably 0.2-10% by weight, are especially C₁-C₁₀-hydroxyalkyl (meth)acrylates, (meth)acrylamides and derivatives thereof substituted on the nitrogen by C₁-C₄-alkyl, ethylenically unsaturated carboxylic acids, dicarboxylic acids, their semi-esters and anhydrides, for example (meth)acrylic acid, maleic acid, fumaric acid, maleic acid anhydride, maleic acid and fumaric acid semi-esters and itaconic acid.

In especially preferred embodiments of the use or the method according to the present invention, said at least one water-dispersed polymer P is selected from poly(meth)acrylate polymers, styrene-(meth)acrylate copolymers, and vinyl-acetate-(meth)acrylate copolymers.

In all embodiments of the use or the method according to the present invention, said at least one water-dispersed polymer P has a glass transition temperature T_{g}, determined with DSC according to ISO 11357 standard, of <0° C., in particular <−5° C., preferably <−10° ° C., more preferably <−20° ° C., most preferably <−30° C.

Preferably, the at least one water-dispersed polymer P has a glass transition temperature (T_{g}), determined with DSC according to ISO 11357 standard, of −60-−5° C., more preferably −50-−10° C. most preferably −40-−10° C. The term “glass transition temperature” refers to the temperature measured by differential scanning calorimetry (DSC) according to the ISO 11357 standard above which temperature a polymer component becomes soft and pliable, and below which it becomes hard and glassy. The measurements can be performed with a Mettler Toledo 822e device at a heating rate of 2° C./min. The T_{g} values can be determined from the measured DSC curve with the help of the DSC software.

Suitable water-dispersed polymers P preferably have a number average molecular weight (Mₙ) in the range of 5,000-200,000 g/mol, preferably 25,000-200,000 g/mol, most preferably 50,000-200,000 g/mol. Suitable water-dispersed polymers P have a weight average molecular weight (M_{w}) in the range of 50,000-800,000 g/mol, preferably 100,000-800,000 g/mol, most preferably 150,000-800,000 g/mol.

Preferably, the at least one water-dispersed polymer P has a number average molecular weight (Mₙ) of not more than 200,000 g/mol and a weight average molecular weight (M_{w}) of at least 100,000 g/mol.

The number average and weight average molecular weights can be determined by gel permeation chromatography using polystyrene as standard in a polymer solution in tetrahydrofuran.

The water-dispersed polymers P can be prepared by free-radical polymerization using substance, solution, suspension or emulsion polymerization techniques, which are known to the person skilled in the art. Preferably, the polymer is obtained by solution polymerization with subsequent dispersion in water or, especially, by emulsion polymerization, so that aqueous polymer dispersions are obtained.

According to one or more embodiments of the present invention, the aqueous polymer dispersion comprises one or more polyacrylate polymers as polymers P. Preferably, the aqueous polymer dispersion is an aqueous polyacrylate dispersion, in which the amount of the other polymers than polyacrylates is less than 5.0% by weight, preferably less than 2.5% by weight, most preferably less than 1.0% by weight, based on the total weight of the aqueous polymer dispersion.

Suitable polyacrylate dispersions and preparation method thereof are described, for example in EP 0490191 A2, DE 19801892 A1, and in EP 0620243.

Suitable commercially available aqueous polyacrylate dispersions of preferred polymers P include Acronal® S 410, Acronal® V 278, Acronal® DS 5017 Acronal® 290 D, Acronal® A323, Acronal® A378, Acronal® 380, Acronal® S 559, Acronal® S 790, Acronal® 5036, Acronal® 5047 (from BASF), Airflex® EAF 60, and Airflex® EAF 67 (from APP), Mowilith® DM 1340 (from Celanese), Primal® CA 162, Primal® E-3362, Primal® 2620, Primal® 928ER, Primal® CA 172, Rhoplex® 4400, and Rhoplex® A920 (from Dow Chemical), Plextol® D 310 (from Synthomer), Vinnapas® EP17, Vinnapas® 240 HD and Vinnapas® EAF68 (from Wacker).

The aqueous polymer dispersion containing preferred embodiments of polymer P can comprise two or more different polyacrylate polymers as polymer P, having different glass transition temperatures and different monomer compositions. Aqueous polymer dispersions comprising two or more different polyacrylate polymers can be prepared by mixing commercially available polyacrylate dispersions, such as those described above.

In especially preferred embodiments of the use or the method according to the present invention, said at least one polymer P comprised in the water-based polymer dispersion composition is at least 22 wt.-%, preferably at least 25 wt.-%, more preferably at least 28 wt.-%, most preferably at least 30 wt.-%, based on the total weight of the water-based polymer dispersion composition.

The water-based polymer dispersion composition to be used in the inventive use and method preferably comprises additionally at least one polyolefin oligomer PIB. The at least one polyolefin oligomer PIB is liquid at 23° C. and under standard pressure.

The term “liquid” means herein that the described substance is a nearly incompressible fluid that conforms to the shape of its container but retains a (nearly) constant volume independent of pressure.

In especially preferred embodiments of the use or the method according to the present invention, the at least one polyolefin oligomer PIB is present in the water-based polymer dispersion composition to be used in the inventive use and method in a total amount of 0.5-10.0% by weight, preferably 1.0-5.0% by weight, more preferably 1.5-4.0% by weight based on the total weight of the water-based polymer dispersion composition.

All polyolefin oligomers that are liquid at the conditions specified above are suitable for the purpose of the invention. The term “polyolefin” does encompass all polymers obtained from the polymerization of olefinic monomers, such as 1-ethylene, propylene, 1-butene, 2-butene, isobutylene, and higher olefins, and mixtures thereof. Preferred monomers include C4 unsaturated monomers such as 1-butylene and isobutylene, which may be employed as a mixture.

In preferred embodiments, the at least one polyolefin oligomer PIB comprises or consists of polybutene oligomers and/or polyisobutylene oligomers. Most preferred are polyisobutylene oligomers.

Suitable and preferred polyiobutylene oligomers for use as polyolefin oligomers PIB include Glissopal® V 190, Glissopal® V 230, Glissopal® V 500, Glissopal® V 640, Glissopal® V 700, and Glissopal® V 1500 (BASF) and Indopol® L-8, Indopol® H-100, and Indopol® H-2100 (INEOS) and Polybut® 150 (KEMAT).

The water-based polymer dispersion composition to be used in the inventive use and method preferably comprises at least one hydrogenated mixture ALK of alkanes, isoalkanes, and/or cycloalkanes with a boiling point of at least 150° C., in particular >200° C., preferably >250° C., more preferably >300° C., most preferably >350° C., that is liquid at 23° C. and under standard pressure. The term “liquid” means herein that the described substance is a nearly incompressible fluid that conforms to the shape of its container but retains a (nearly) constant volume independent of pressure.

Preferably, the boiling point of the at least one hydrogenated mixture ALK of alkanes, isoalkanes, and/or cycloalkanes is >200° C., preferably >250° C., more preferably >300° C., most preferably >350° C.

The at least one hydrogenated mixture ALK of alkanes, isoalkanes, and/or cycloalkanes preferably comprises alkanes, isoalkanes, and/or cycloalkanes based on C10-C30 fractions, preferably C12-C25 fractions, more preferably C13-C23 fractions.

The at least one hydrogenated mixture ALK of alkanes, isoalkanes, and/or cycloalkanes preferably comprises aromatics (hydrocarbons with aromatic moieties) such as substituted or non-substituted benzene and substituted or non-substituted naphthalene with an amount of <1 wt.-%, preferably <0.5 wt.-%, more preferably <0.1 wt-%.

Suitable as at least one hydrogenated mixture ALK of alkanes, isoalkanes, and/or cycloalkanes are for example Hydroseal® G 400 H, Hydroseal® G 280 H, Hydroseal® G 3H (TOTAL).

Preferably, the at least one hydrogenated mixture ALK of alkanes, isoalkanes, and/or cycloalkanes is present in the water-based polymer dispersion composition in a total amount of 0.5-10.0% by weight, preferably 1.0-5.0% by weight, most preferably 1.5-4.0% by weight, based on the total weight of the water-based polymer dispersion composition.

The water-based polymer dispersion composition to be used in the inventive use and method preferably comprises at least one filler.

A filler influences the rheological properties of the uncured composition and also the mechanical properties and the surface nature of the fully cured composition. Suitable fillers are inorganic and organic fillers, as for example natural, ground or precipitated chalks (which consist entirely or primarily of calcium carbonate), and which are optionally coated with fatty acids, more particularly stearic acid; barium sulfate (BaSO₄, also called barite or heavy spar), calcined kaolins, aluminum oxides, aluminum hydroxides, silicas, especially finely divided silicas from pyrolysis processes, carbon blacks, especially industrially manufactured carbon black, titanium dioxide, PVC powders, or hollow beads. Preferred fillers are calcium carbonates, calcined kaolins, carbon black, finely divided silicas, and flame-retardant fillers, such as hydroxides or hydrates, especially hydroxides or hydrates of aluminum, preferably aluminum hydroxide.

It is entirely possible and may even be an advantage to use a mixture of different fillers.

Very preferred as filler for the composition of the invention is chalk (calcium carbonate). Especially preferred is uncoated chalk, most preferably uncoated, ground chalk, as available for example under the name Omyacarb® 40 GU (Omya AG, Switzerland).

The type and amount of filler is not particularly limited in the present invention. Examples of suitable fillers include calcium carbonate, calcium sulfate and calcium containing minerals such as limestone, calcite, chalk, dolomite, wollastonite, gypsum, apatite, phosphate rock, and mixtures thereof.

The term “filler” refers in the present disclosure to solid particulate materials, which are commonly used as fillers in water-based polymer dispersion compositions, and which have low water-solubility. Preferably, the filler has a water-solubility of less than 0.1 g/100 g water, more preferably less than 0.05 g/100 g water, most preferably less than 0.01 g/100 g water, at a temperature of 20° C.

Preferably, the filler has a median particle size d₅₀ in the range of 1.0-100.0 μm, more preferably of 1.0-60.0 μm, most preferably 2.0-50.0 μm.

The term “median particle size d₅₀” refers in the present disclosure to a particle size below which 50% of all particles by volume are smaller than the d₅₀ value. The term “particle size” refers to the area-equivalent spherical diameter of a particle. The particle size distribution can be measured by laser diffraction according to the method as described in standard ISO 13320:2009. A Mastersizer 2000 device (trademark of Malvern Instruments Ltd, GB) can be used in measuring particle size distribution.

Preferably, the one or more fillers are present in the water-based polymer dispersion composition in a total amount of 10.0-60.0% by weight, preferably 20.0-60.0% by weight, most preferably 40.0-60.0% by weight, based on the total weight of the water-based polymer dispersion composition.

In the same or different preferred embodiments, said filler preferably comprises chalk and/or dolomite.

According to one or more embodiments, in particular where the intended use of the polymer dispersion composition is as a coating, the water content of the polymer dispersion composition is 10-70% by weight, preferably 15-60% by weight, most preferably 20-50% by weight, based on the total weight of the polymer dispersion composition.

According to one or more embodiments, in particular where the intended use of the polymer dispersion composition is as a joint sealant or adhesive, the water content of the polymer dispersion composition is 5-45% by weight, preferably 10-35% by weight, most preferably 12-30% by weight, based on the total weight of the polymer dispersion composition.

According to one or more embodiments, the polymer dispersion composition has a solids content of 40-95% by weight, preferably 50-90% by weight, most preferably 65-85% by weight.

The solids content as used herein refers to the portion of the aqueous polymer dispersion composition, which when heated to a temperature of 105° C. for one hour at one atmosphere pressure does not volatilize. Accordingly, the solids content refers to polymeric materials, non-volatile plasticizers, inorganic solids and non-volatile organic materials, whereas the non-solid portion is generally comprised of water and any organic materials readily volatilized at 105° C.

According to one or more embodiments, the weight ratio of water to polymer P in the polymer dispersion composition is between of 3:2 and 1:4, preferably between 1:1 and 1:3, most preferably between 9:11 and 3:7.

According to one or more embodiments, the water-dispersed polymers P are present in the polymer dispersion composition in a total amount of 21.0-65.0% by weight, preferably 25.0-55.0% by weight, most preferably 30.0-45.0% by weight, based on the total weight of the polymer dispersion composition.

The water-based polymer dispersion composition to be used in the inventive use and method optionally and preferably contains one or more plasticizers PL having at least one ester or ether group. The amount of plasticizer PL depends on the intended application and the polymer P used. Very soft polymers P with a very low T_{g}, such as for example −60° C., do not necessarily require the addition of a plasticizer PL or work with very little amounts thereof. When using a polymer P with a higher T_{g}, such as for example −10° C., the use, preferably of of higher amounts, of plasticizer PL is recommended.

The one or more plasticizers PL having at least one ester or ether group are preferably used in the water-based polymer dispersion composition with a total amount of 0.5-30.0% by weight, preferably 1.0-20% by weight, in particular 2.5-15.0% by weight, based on the total weight of the water-based polymer dispersion composition.

Suitable plasticizers PL are liquid or solid inert organic substances having a low vapor pressure, preferably having a boiling point of above 200° C. measured at standard pressure. Plasticizers can be selected from the group consisting of adipic and sebacic acid plasticizers, phosphoric acid plasticizers, citric acid plasticizers, fatty acid esters and epoxidised fatty acid esters, polypropylene glycol, polyethylene glycol, benzoates, and phthalates or esters of 1,2-dicarboxy cyclohexane. #

Suitable fatty acid esters include alkyl esters of fatty acids containing more than 14 or more than 16 carbon atoms, for example the alkyl esters of lauric, myristic, stearic, arachidic and behenic acid and mixtures thereof. Suitable as fatty alcohols are the alcohols of the above-mentioned fatty acids, such as are obtainable from the fatty acids or esters thereof by use of processes known to the person skilled in the art.

In preferred embodiments of the or the method according to the present invention, the plasticizer PL having at least one ester or ether group is selected from phthalate esters, cyclohexane esters, or benzoate esters.

In especially preferred embodiments of the use or the method according to the present invention, said plasticizer PL is a phthalate ester or a hydrogenated phthalate ester, preferably 1,2-cyclohexane dicarboxylic acid diisononyl ester.

In especially preferred embodiments of the use or the method according to the present invention, the water-based polymer dispersion composition comprises at least one plasticizer PL as described above and/or comprises at least one polyolefin oligomer PIB as described above and/or comprises at least one hydrogenated mixture ALK of alkanes, isoalkanes, and/or cycloalkanes as described above, wherein the total amount in the composition before drying of the combined amounts of polyolefin oligomer PIB and hydrogenated mixture ALK and plasticizer PL is between 0 and 20% by weight, preferably between 3 and 15% by weight, more preferably between 5 and 10% by weight, based on the total water-based polymer dispersion composition.

The water-based polymer dispersion composition to be used in the inventive use and method further comprises at least one surfactant, preferably a non-ionic surfactant. A surfactant is required to ensure homogeneity of the composition before application and sufficient wetting of the substrates in the inventive use or method.

Suitable surfactants include anionic, non-ionic, cationic or amphoteric surfactants, but preferably a non-ionic or anionic surfactant is employed, most preferably a non-ionic surfactant. Generally, the amount of surfactant employed will range from 0.1 to 5% by weight, based on the total weight of the polymer dispersion composition.

Suitable and preferred non-ionic surfactants include polyethylene oxide condensates of alkylphenols, polyoxyalkylene derivatives of propylene glycol, condensates of ethylene oxide and the reaction product of propylene oxide and ethylene diamine, ethylene oxide condensates of aliphatic alcohols, long chain tertiary amine oxides, long chain tertiary phosphine oxides, fatty acid ethoxylates, and long chain dialkyl sulfoxides. Useful anionic surfactants include those obtained by alkylating aromatic nuclei, sulfonating the resulting alkylated aromatic hydrocarbons, and neutralizing the sulfonation products. Alkyl benzene sulfonates, such as dodecylbenzene sulfonate are typical of this class. Fatty alcohol sulfates are also useful as surface active agents. Preferred are fatty acid ethoxylates.

The water-based polymer dispersion composition to be used in the inventive use and method further comprises at least one dispersant, in particular a polymeric ammonium or sodium salt of a carboxylic acid copolymer. A dispersant is required to ensure stability of the dispersion, especially when high amounts of polymer P and/or fillers are used.

Suitable dispersants include all dispersants commonly used in the field of water-based polymer dispersion compositions, but preferably a non-ionic or anionic surfactant is employed, most preferably a polymeric ammonium salt of a carboxylic acid copolymer is used. These types of dispersants have an especially high compatibility with the preferred polymers P and show an especially good dispersion stability. Generally, the amount of dispersant employed will range from 0.1 to 5% by weight, based on the total weight of the polymer dispersion composition.

The water-based polymer dispersion composition to be used in the inventive use and method can further comprise one or more tackifiers. Examples of suitable tackifiers may include hydrocarbon resins or hydrogenated products thereof, rosins or hydrogenated products thereof, rosin esters or hydrogenated products thereof, terpene resins or hydrogenated products thereof, terpene phenolic resins or hydrogenated products thereof, and polymerized rosins or polymerized rosin esters or acrylic liquid resins.

The water-based polymer dispersion composition to be used in the inventive use and method can also contain one or more further additives such as wetting agents, emulsifiers, thickeners, anti-foaming agents, flame retardants, stabilizers, colorants, antioxidants, UV-absorbers and/or biocides. Such further additives commonly used in water-based dispersion additives are known to a person skilled in the art.

Suitable anti-foams are preferably compounds based on mineral oils or silicones. Suitable thickeners include compounds that are based on (meth)acrylic acid copolymers, cellulose derivatives, mineral thickeners such as clays, silica, or mixtures thereof.

Biocides (preservatives) may be added to the polymer dispersion composition according to the present invention in an amount of up to 2% by weight, preferably between 0.2% by weight and 1.8% by weight, more preferably between 0.4% by weight and 1.5% by weight, with respect to the total polymer dispersion composition, of a biocide.

In general, any known type of biocides, also denoted as preservatives, can be used in the composition of the present invention.

Suitable as preservatives are customary preservatives, for example benzisothiazolinone (BIT), methylisothiazolinone (MIT), octylisothiazolinone (OIT), and chloromethyl isothiazolinone (CMIT).

According to one or more embodiments, the total amount of the further additives is preferably 0-15.0% by weight, more preferably 0-10.0% by weight, based on the total weight of the polymer dispersion composition.

The polymer dispersion composition can be prepared by mixing the ingredients together at room temperature. Any suitable mixing apparatus can be used for the preparation of the polymer dispersion composition.

When used as adhesive, the polymer dispersion composition is especially suitable for bonding and sealing applications in the construction industry on alkaline substrates, especially for parquet bonding on fresh cement screed or for the bonding of components on fresh concrete.

When used as sealant, the polymer dispersion composition is especially suitable for the sealing of joints, seams or cavities of alkaline substrates in construction, especially for the sealing of dilation joins or connection joins between components.

When used as coating, the polymer dispersion composition is especially suitable for the protection of alkaline substrates, especially floors or walls, especially as coating of balconies, terraces, open spaces, bridges, parking levels, or for the sealing of roofs, especially flat roofs or slightly inclined roof areas or roof gardens, or in the interior of buildings for water sealing, for example beneath tiles or ceramic plates in plumbing units or kitchens, or as floor covering in kitchens, industrial buildings or manufacturing spaces, or as a seal in collection tanks, channels, shafts, silos, tanks or wastewater treatment plants.

The polymer dispersion composition is especially suitable for sealing joints in or coating alkaline substrates having a pH of at least 10 when wetted with water, including fresh concrete, fresh cement mortar, fresh lime mortar, or a fresh lime or silicate paint. However, the polymer dispersion composition is also suitable for other substrates commonly found in construction, such as wood, metals and alloys, dried mineral or concrete substrates, natural stone, and other substrates commonly found in construction.

The polymer dispersion composition according to the present invention has preferably a tackiness, after drying in air during 28 d at 23° C. with a relative humidity of 50%, of 0 (zero) grams, as defined by the amount of quartz sand (0.7 mm-1.2 mm particle size) that is poured on the surface of a test specimen in the form of a disc with a diameter of 4.2 mm and a height of 5 mm and dried in air at 23° C. and 50% r.h., when the test specimen is turned around 180° after addition of the sand, the sand-covered side facing downwards, and the amount of sand still adhering to the surface is used to determine said tackiness.

The water-based polymer dispersion composition to be used in the inventive use and method preferably exhibits a Shore A hardness, after drying in air during 28 d at 23° C. with a relative humidity of 50%, of less than 50, in particular between 5 and 40, preferably between 10 and 35, more preferably between 15 and 30, most preferably between 15 and 25. The Shore A hardness is most preferably about 20.

According to another aspect of the present invention, a method for sealing a joint between two substrates and/or coating a surface of a substrate and/or adhesively joining two substrates in provided, the method comprising steps of:
i) Applying a water-based polymer dispersion composition as described further above into the joint between two substrates and/or onto a surface of a substrate to form a wet film of composition thereon,
ii) Optionally joining a second substrate to the first substrate such that the wet film on the first substrate is in contact with the second substrate, or such that both wet films on both substrates are in contact with each other, to effect bonding there between,
iii) Exposing the wet sealant in the filled joint and/or the wet film of sealant on the surface to air until the joint sealant and/or surface film is dry,
wherein at least one of the substrate surfaces onto which the wet composition is applied onto consists of an alkaline substrate having a pH of at least 10 when wetted with water, wherein said alkaline substrate is fresh concrete, fresh cement mortar, fresh lime mortar, or a fresh lime or silicate paint.

All embodiments of the water-based polymer dispersion composition described for the inventive use apply also to the inventive method described here, in particular also preferred embodiments of the water-based polymer dispersion compositions or it's ingredients or properties.

Concrete and other hydraulic binder compositions are commonly applied in liquid form into a mold and left for initial hardening after which the mold is removed. At this point the concrete has begun hardening, but still is “green” and highly alkaline on the surface. Only after demolding the excess water can evaporate and final drying can take place. Common curable compositions of the state of the art, as discussed in the introduction of this document, are normally applied weeks after demolding of the concrete to ensure a sufficient drying and low alkalinity of the surface.

In preferred embodiments of the method according to the present invention as described further above, the water-based polymer dispersion composition is applied onto said alkaline substrate within 10 days, preferably within 8 days, more preferably within 5 days, most preferably within 3 days after the alkaline substrate itself has been applied in wet, uncured form or has been demolded in case of an initially molded substrate such as concrete. Most preferably, the water-based dispersion composition is applied onto the substrate between 1 and 3 days after the still alkaline substrate has been applied or demolded.

In preferred such embodiments, the water-based polymer dispersion composition is applied onto a demolded concrete substrate, preferably onto a surface thereof that was covered by the mold before demolding.

The polymer dispersion composition can be applied on the surface of the substrate using for example, a toothed trowel or a roller.

### Examples

The invention is further explained in the following experimental part which, however, shall not be construed as limiting to the scope of the invention. The proportions and percentages indicated are by weight, unless otherwise stated. Accordingly, “wt.-%” means percentage by weight, based on the weight of the total composition given in the respective case. “RT” means room temperature or ambient temperature and describes a temperature of 23° C. The abbreviation “r.h.” or “% r.h.” means relative humidity (in %) of the ambient air in a given example or test method.

### Test Methods

The adhesion properties (failure mode) were determined by bead adhesion test at 23° C. in accordance with DIN EN ISO 21194 on green (fresh) concrete samples of different ages. One test series was done on green concrete 24 h after demolding, the second series 3 days after the green concrete's demolding, and a third series 6 days after the green concrete's demolding. The adhesion samples of the tested polymer dispersion compositions were dried during 28 days at room temperature. A second series of samples were dried likewise, but additionally subjected to water immersion for 7 days (28 d RT plus 7 days H₂O). A third series of samples was again additionally subjected to a temperature of 40° C. for 7 days before adhesion was evaluated (28 d RT plus 7 days H₂O plus 7 d 40° C.). The adhesion properties in Tables 6 to 9 are rated from 1 to 5, wherein 1 is the best adhesion (100% cohesive failure) and 5 is the worst adhesion (100% adhesive failure). The increasing numbers 2 to 4 in between denote adhesion profiles with increasingly adhesive failure patterns and thus increasingly worse adhesion properties.

### Production of Concrete Substrates:

The adhesion was tested on fresh cement mortar prisms produced as follows:

A series of different green concrete samples C-1 to C-5 was prepared to be used as substrates in the adhesion tests. The exact composition of each concrete sample is listed in Table 1.

In all preparations, a dry mix was produced first by mixing all solid constituents (such as cement, sand, fillers, etc.) until visually homogeneous.

Then, a liquid mixture was prepared by mixing all liquid constituents, including water, into a homogeneous liquid mixture.

The liquid mixture was then added to the dry mix under manual stirring until a homogeneous, viscous mixture was obtained.

The thus obtained homogeneous concrete mixture was then poured into silicone molds lined with PTFE foil. The final dimension of each fresh concrete sample was 14.5 cm×14.5 cm×1 cm and having a weight of approximately 100 g.

The samples were then stored under standard climatic conditions.

After 24 hours, the cured but still fresh concrete substrates samples were taken out of the molds, partially brushed on the outside with a steel brush and freed of dust. Test polymer dispersion compositions as described below were applied after the above specified waiting time (24 h, 3 d, or 6 d under standard climatic conditions, i.e., 23° C. and 50% r.h.) to the fresh (green) mortar prisms thus prepared and demolded.

TABLE 1
Example compositions.

| Ingredient (weight parts) | C-1 | C-2 | C-3 | C-4 | C-5 |
|---|---|---|---|---|---|
| Portland Cement CEM I 42.5N SVW | 17.7 | 17.7 | 17.7 | 17.7 | 17.7 |
| Chalk filler (nekafill ® 15; Kalkfabrik Netstal | 7.9 | 7.9 | 7.9 | 7.9 | 7.9 |
| AG) | | | | | |
| Sand (0-1 mm) | 28.5 | 28.5 | 28.5 | 28.5 | 28.5 |
| Sand (1-4 mm) | 35.3 | 35.3 | 35.3 | 35.3 | 35.3 |
| Water | 10.6 | 10.6 | 15.9 | 11.9 | 11.9 |
| Superplasticizer (Sikament-210 ® N; Sika | 0.10 | — | — | — | — |
| AG) | | | | | |
| Superplasticizer (Sika ® ViscoCrete ®-4027) | — | — | — | — | 0.325 |

* adjusted to pH 8 by NaOH (25 wt.-% in water)

### Raw Materials for Example Water-Based Polymer Dispersion Compositions

The raw materials and their description regarding important properties which were used for the example polymer dispersion compositions are shown in

TABLE 2
Table 2: Raw materials used for the example compositions.

| Raw material | Description |
|---|---|
| Acronal V278 | Aqueous acrylate (polymer P) dispersion. 65% solids *, |
| | T_{g} = −40° C. (Acronal ® V 278 by BASF) |
| VAc-EHA | Aqueous dispersion of vinylacetate-ethylhexylacrylate |
| | copolymer (polymer P) with T_{g} = −10° C., 52% solids * |
| Axilat DS 910 | Aqueous dispersion of styrene acrylate compolymer with T_{g} = |
| | 24° C., 50% solids * |
| ECO 6716 | Aqueous dispersion of styrene acrylate compolymer with T_{g} = |
| | 22° C., 50% solids * (Acronal ® ECO 6716 by BASF) |
| AC 31 | Aqueous acrylate dispersion with T_{g} = 40° C., 50% solids * |
| | (ALBERDINGK ® AC 31 by Alberdingk Boley) |
| PST 50A | Aqueous dispersion of styrene acrylate compolymer with T_{g} = |
| | 20° C., 50% solids * (Orgal ® PST 50 A by Organikkimya) |
| Nonionic surfactant | Fatty alcohol ethoxylate |
| Dispersant | Polycarboxylate ammonium salt |
| DINP | Diisononylphthalate (plasticizer) |
| DINCH | 1,2-Cyclohexane dicarboxylic acid diisononyl ester |
| | (plasticizer) |
| Hydroseal G400 H | Hydrogenated mixture of C13-C23 n-alkanes, isoalkanes, |
| | cycloalkanes, <0.03% aromatics (Hydroseal ® G 400 H by |
| | Total) |
| Glissopal V1500 | Polyisobutylene oligomer. Mn = 2300 g/mol (GPC) |
| | (Glissopal ® V 1500 by BASF) |
| CaCO₃ | Ground natural calcium carbonate (filler); median particle size |
| | (d₅₀): 5 μm |
| Dolomite | Ground natural dolomite (filler); median particle size (d₅₀): 5.5 μm |
| TiO₂ | Titanium dioxide (filler, brightener) |
| Acrylic thickener | Acrylic dispersion. 30% solids. |
| Clay thickener | Inert powdered gelling grade of attapulgite. |

* “solids” defines the weight concentration of polymer P in the respective aqueous dispersion.

### Example Compositions

Several inventive and non-inventive (reference) polymer dispersion compositions were prepared from the raw materials in Table 2 using the following procedure.

### Mixing Procedure

All example compositions were prepared in a lab mixer using the following procedure:
a) Adjustment of the Acronal V278 acrylic dispersion or VAc-EHA dispersion to pH 8 by using caustic soda (25 wt.-% NaOH in water).
b) Addition of the liquid raw materials except the acrylic thickener.
c) Addition of the powder raw materials in several steps, each interrupted by stirring. After addition of all powders, dispersing of the powders during 10 min.
d) Addition of the acrylate thickener.
e) Mixing under vacuum and filling of the preparations into cartridges.
f) Storing the cartridges for at least 24 h at 23° C. and 50% r.h. prior to initiating the testing procedure.

### Details of the Example Compositions

Several non-inventive reference (denoted “R”) and inventive (denoted “I”) example compositions were made from the raw materials in Table 1 according to the mixing procedure detailed above. The compositions and the relative amounts (in wt.-%) of the raw materials are shown in Tables 3 and 4.

TABLE 3
Example compositions.

| Ingredient (wt.-%) | I1 | I2 | I3 | I4 | R5 | R6 | I7 | R8 |
|---|---|---|---|---|---|---|---|---|
| Acronal V278 (pH 8 *) | 37 | 37 | 37 | 37 | 29 | 21 | 37 | — |
| VAc-EHA (pH 8 *) | — | — | — | — | — | — | — | 32.3 |
| Nonionic surfactant | 0.5 | 0.5 | 0.5 | 0.5 | 0.5 | 0.5 | 0.5 | 0.5 |
| Dispersant | 0.5 | 0.5 | 0.5 | 0.5 | 0.5 | 0.5 | 0.5 | 0.4 |
| DINP | 4 | 6 | 6 | 8 | 5.5 | 7 | — | 6 |
| DINCH | — | — | — | — | — | — | 4 | — |
| Hydroseal G400 H | 2 | — | 2 | — | 2 | 2 | 2 | — |
| Glissopal V1500 | 2 | 2 | — | — | 2 | 2 | 2 | — |
| CaCO₃ | 52 | 52 | 52 | 52 | 58.5 | 65 | — | — |
| Dolomite | — | — | — | — | — | — | 50.1 | 58.3 |
| TiO₂ | — | — | — | — | — | — | 2 | 1.5 |
| Acrylic thickener | 1 | 1 | 1 | 1 | 1 | 1 | 1 | 1 |
| Clay thickener | 1 | 1 | 1 | 1 | 1 | 1 | 0.9 | 1 |

* Adjusted to pH 8 by NaOH (25 wt.-% in water)

TABLE 4
Example compositions.

| Ingredient (wt.-%) | I9 | I10 | I11 | I12 | I13 | I14 | I15 |
|---|---|---|---|---|---|---|---|
| Acronal V278 | 40.3 | 39.4 | 38.6 | 37.8 | 37.1 | 36.4 | 35.7 |
| (pH 8 *) | | | | | | | |
| Nonionic surfactant | 0.5 | 0.5 | 0.5 | 0.5 | 0.5 | 0.5 | 0.5 |
| Dispersant | 0.5 | 0.5 | 0.5 | 0.5 | 0.5 | 0.5 | 0.5 |
| DINP | 0 | 2.1 | 4.2 | 6.2 | 8 | 9.8 | 11.6 |
| Dolomite | 57.1 | 55.9 | 54.6 | 53.4 | 52.3 | 51.2 | 50.1 |
| Acrylic thickener | 0.6 | 0.6 | 0.6 | 0.6 | 0.6 | 0.6 | 0.6 |
| Clay thickener | 1 | 1 | 1 | 1 | 1 | 1 | 1 |

* Adjusted to pH 8 by NaOH (25 wt.-% in water)

### Other Reference Compositions

Additional reference sealants or adhesives were used in some test protocols. These reference compositions are commercially available products based on different chemically curing matrix polymers. They are listed in the following

TABLE 5
Table 5: Reference sealants used as comparison to the inventive compositions.

| | |
|---|---|
| R16 | “Sikaflex ® Construction+” (one-component moisture-curing polyurethane |
| | sealant, available from Sika Schweiz) |
| R17 | “Sikaflex ® AT Connection” (one-component moisture-curing sealant based |
| | on silane-terminated polymers, available from Sika Schweiz) |
| R18 | “Sikasil ® WS-605 S” (RTV-1 silicone sealant available from Sika Schweiz) |

### Test Results of Adhesion Tests on Different Green Concrete Samples

The results of the test methods used on each example composition are detailed in Tables 6 to 9. The term “RT” means a storage of the applied sample of test composition on green concrete under standard climatic conditions (23° C., 50% relative air humidity) for the denoted time in days (“d”). “40° C.” denotes a storage in an oved at 40° C. “H₂O” denotes a storage immersed in water.

TABLE 6
Test results (adhesion on green concrete with
an age of 24 h and 3 d, respectively).

| Concrete | Conditions | I1 | I2 | I3 | I4 | R5 | R6 | I7 | R8 |
|---|---|---|---|---|---|---|---|---|---|
| C-1 (24 h) | 28 d RT | 1 | 2 | 2 | 2 | 5 | coa | 1 | 5 |
| C-1 (24 h) | 28 d RT + 7 d 40° C. | 4 | 4 | 4 | 4 | 5 | coa | 1 | 5 |
| C-1 (24 h) | 28 d RT + 7 d 40° C. + | 3 | 1 | 1 | 2 | 5 | coa | 1 | 5 |
| | 7 d H₂O | | | | | | | | |
| C-1 (3 d) | 28 d RT | 2 | 2 | 3 | 2 | 5 | coa | n/m | 5 |
| C-1 (3 d) | 28 d RT + 7 d 40° C. | 4 | 4 | 4 | 4 | 5 | coa | n/m | 5 |
| C-1 (3 d) | 28 d RT + 7 d 40° C. + | 3 | 3 | 1 | 3 | 5 | coa | n/m | 5 |
| | 7 d H₂O | | | | | | | | |

“coa” means the sample coagulated and was unusable. “n/m” means the test was not done and the corresponding value was not measured.

The results of Table 6 show that the inventive compositions 11-14 and 17 show a significantly better adhesion on green concrete than reference compositions R5 and R8. Reference composition R6, having a far too low content of polymer P (13% by weight, based on the total composition), coagulated and could not be used in the test protocol.

TABLE 7
Test results (adhesion on green concrete
samples C-2 and C-3, with an age of 6 d).

| Concrete | Conditions | I9 | I10 | I11 | I12 | I13 | I14 |
|---|---|---|---|---|---|---|---|
| C-2 | 14 d RT | 1 | 1 | 1 | 1 | 1 | 1 |
| | +7 d H₂O | 4 | 4 | 3 | 2 | 1 | 1 |
| | +7 d 40° C. | 3 | 2 | 2 | 2 | 1 | 1 |
| C-3 | 14 d RT | 1 | 1 | 1 | 1 | 1 | 1 |
| | +7 d H₂O | 4 | 3 | 2 | 1 | 1 | 1 |
| | +7 d 40° C. | 2 | 1 | 1 | 1 | 1 | 1 |

The results in Table 7 show that softer compositions (with higher amount of plasticizer) lead to an advantageous improvement of adhesion and adhesion stability, especially after water- and subsequently heat-storage.

TABLE 8
Test results (adhesion on green concrete
samples C-2 and C-3, with an age 6 d).

| Concrete | Conditions | I15 | I7 | R8 | R16 | R17 |
|---|---|---|---|---|---|---|
| C-2 | 14 d RT | 1 | 1 | 2 | 5 | 2 |
| | +7 d H₂O | 1 | 1 | des | 5 | 5 |
| | +7 d 40° C. | 1 | 1 | des | 5 | 5 |
| C-3 | 14 d RT | 1 | 1 | 1 | 5 | 5 |
| | +7 d H₂O | 1 | 1 | des | 5 | 5 |
| | +7 d 40° C. | 1 | 1 | des | 5 | 5 |

“des” means that the sealant sample disintegrated (destroyed) during measurement storage.

TABLE 9
Test results (adhesion on green concrete
samples C-3 to C-5, with an age of 6 d).

| | | I7 | | R8 | | R16 | | R17 | | R18 | |
|---|---|---|---|---|---|---|---|---|---|---|---|
| Concrete | Conditions | f | s | f | s | f | s | f | s | f | s |
| C-4 | 14 d RT | 3 | 4 | 4 | 4 | 2 | 5 | 1 | 5 | 5 | 5 |
| | +7 d H₂O | 1 | 1 | 5 | 5 | 5 | 4 | 5 | 5 | 5 | 5 |
| | +7 d 40° C. | 1 | 2 | 5 | 5 | 5 | 4 | 5 | 5 | 5 | 5 |
| C-3 | 14 d RT | 1 | 5 | 4 | 5 | 5 | 3 | 3 | 5 | 5 | 5 |
| | +7 d H₂O | 1 | 2 | 5 | 5 | 5 | 5 | 5 | 5 | 5 | 5 |
| | +7 d 40° C. | 2 | 4 | 5 | 5 | 5 | 3 | 5 | 5 | 5 | 5 |
| C-5 | 14 d RT | 1 | 1 | 3 | 3 | 4 | 5 | 5 | 4 | 3 | 5 |
| | +7 d H₂O | 1 | 1 | 5 | 5 | 5 | 5 | 5 | 5 | 5 | 5 |
| | +7 d 40° C. | 1 | 1 | 5 | 5 | 5 | 5 | 5 | 5 | 5 | 5 |

“f” means a flat, untreated concrete sample and “s” means a concrete sample that was sanded to roughen the surface before application of the composition.

The results in Tables 8 and 9 show that only water-based polymer dispersion compositions according to the invention lead to sufficient and lasting adhesion on green concrete. Sealants based on other curing chemistries, including polyurethanes, organic silane-modified polymers, and silicones are not able to perform as adhesively stable sealants on green concrete. This is true both for untreated and mechanically surface-treated concrete surfaces.

### Further Reference Compositions

Several further non-inventive reference (denoted “R”) example compositions were made from the raw materials in Table 1 according to the mixing procedure detailed above.

These reference compositions use dispersions of polymers that exhibit a too high T_{g} (>0° C.) to be suitable for the use according to the invention.

The compositions and the relative amounts (in wt.-%) of the raw materials are shown in Table 10.

TABLE 10
reference compositions.

| Ingredient (wt.-%) | R19 | R20 | R21 | R22 | R23 |
|---|---|---|---|---|---|
| Axilat DS 910 (pH 8 *) | 32 | 32 | — | — | — |
| ECO 6716 (pH 8 *) | — | — | 32 | — | — |
| AC 31 (pH 8 *) | — | — | — | 32 | — |
| PST 50A (pH 8 *) | — | — | — | — | 32 |
| Nonionic surfactant | 0.5 | 0.5 | 0.5 | 0.5 | 0.5 |
| Dispersant | 0.5 | 0.5 | 0.5 | 0.5 | 0.5 |
| DINP | — | 10 | 10 | 10 | 10 |
| Dolomite | 65 | 55 | 55 | 55 | 55 |
| Acrylic thickener | 1 | 1 | 1 | 1 | 1 |

* Adjusted to pH 8 by NaOH (25 wt.-% in water)

The compositions R19-R23 were subsequently tested on green concrete with the protocol described above and shown in table 6. The results of these adhesion tests are shown in Table 11.

TABLE 11
Test results (adhesion on green concrete with
an age of 24 h and 3 d, respectively).

| Concrete | Conditions | R19 | R20 | R21 | R22 | R23 |
|---|---|---|---|---|---|---|
| C-1 (24 h) | 28 d RT | 5 | 5 | 5 | 5 | 5 |
| C-1 (24 h) | 28 d RT + 7 d 40° C. | 5 | 5 | 5 | 5 | 5 |
| C-1 (3 d) | 28 d RT | 5 | 5 | 5 | 5 | 5 |
| C-1 (3 d) | 28 d RT + 7 d 40° C. | 5 | 5 | 5 | 5 | 5 |

The data in Table 11 shows that compositions based on polymers with a T_{g} above 0° C. are not suitable for the use of the present invention.

1. The use of a water-based polymer dispersion composition comprising
a) more than 20% by weight, based on the total composition, of at least one water-dispersed polymer P, dispersed in water in a concentration of between 40 and 80% by weight based on the dispersion of water-dispersed polymer P, wherein said at least one water-dispersed polymer P has a glass transition temperature T_{g}, determined with DSC according to ISO 11357 standard, of <0° C.,
b) at least one surfactant,
c) at least one dispersant, and
d) optionally at least one plasticizer PL having at least one ester or ether group, as an adhesive, sealant, or coating applied onto at least one alkaline substrate having a pH of at least 10 when wetted with water, wherein the alkaline substrate is fresh concrete, fresh cement mortar, fresh lime mortar, or a fresh lime or silicate paint.

2. The use according to claim 1, wherein said at least one water-dispersed polymer P is selected from poly(meth)acrylate polymers, styrene-(meth)acrylate copolymers, and vinyl-acetate-(meth)acrylate copolymers.

3. The use according to claim 1, wherein said at least one water-dispersed polymer P has a glass transition temperature T_{g}, determined with DSC according to ISO 11357 standard, of <−5° C.

4. The use according to claim 1, wherein the water-based polymer dispersion composition furthermore comprises at least one polyolefin oligomer PIB that is liquid at 23° C. and under standard pressure.

5. The use according to claim 1, wherein the water-based polymer dispersion composition furthermore comprises at least one hydrogenated mixture ALK of alkanes, isoalkanes, and/or cycloalkanes with a boiling point of at least 150° C., that is liquid at 23° C. and under standard pressure.

6. The use according to claim 1, wherein the amount of said at least one polymer P comprised in the water-based polymer dispersion composition is at least 22 wt.-%, based on the total weight of the water-based polymer dispersion composition.

7. The use according to claim 1, wherein the water-based polymer dispersion composition exhibits a Shore A hardness of less than 50 after drying in air during 28 d at 23° C. with a relative humidity of 50%.

8. The use according to claim 1, wherein the composition furthermore comprises at least one filler in an amount of between 40 and 60% by weight, based on the total composition.

9. The use according to claim 4, wherein the at least one polyolefin oligomer PIB is present in the water-based polymer dispersion composition in a total amount of 0.5-10.0% by weight, based on the total weight of the water-based polymer dispersion composition.

10. The use according to claim 5, wherein the at least one hydrogenated mixture ALK of alkanes, isoalkanes, and/or cycloalkanes is present in the water-based polymer dispersion composition in a total amount of 0.5-10.0% by weight, based on the total weight of the water-based polymer dispersion composition.

11. The use according to claim 1, wherein the water-based polymer dispersion composition comprises at least one plasticizer PL and/or comprises at least one polyolefin oligomer PIB and/or comprises at least one hydrogenated mixture ALK of alkanes, isoalkanes, and/or cycloalkanes, wherein the total amount in the composition before drying of the combined amounts of polyolefin oligomer PIB and hydrogenated mixture ALK and plasticizer PL is between 0 and 20% by weight, based on the total water-based polymer dispersion composition.

12. The use according to claim 1, wherein said plasticizer PL is a phthalate ester or a hydrogenated phthalate ester.

13. A method for sealing a joint between two substrates and/or coating a surface of a substrate and/or adhesively joining two substrates, the method comprising steps of:
i) Applying a water-based polymer dispersion composition according to claim 1 into the joint between two substrates and/or onto a surface of a substrate to form a wet film of composition thereon,
ii) Optionally joining a second substrate to the first substrate such that the wet film on the first substrate is in contact with the second substrate, or such that both wet films on both substrates are in contact with each other, to effect bonding there between,
iii) Exposing the wet sealant in the filled joint and/or the wet film of sealant on the surface to air until the joint sealant and/or surface film is dry,
wherein at least one of the substrate surfaces onto which the wet composition is applied consists of an alkaline substrate having a pH of at least 10 when wetted with water, wherein said alkaline substrate is fresh concrete, fresh cement mortar, fresh lime mortar, or a fresh lime or silicate paint.

14. The method according to claim 13, wherein the water-based polymer dispersion composition is applied onto said alkaline substrate within 10 days after the alkaline substrate itself has been applied or produced in wet, uncured form or has been demolded.

15. The method according to claim 14, wherein the water-based polymer dispersion composition is applied onto a demolded concrete substrate.
